(19) United States
(12) Patent Application Publication
(10) Pub. No.: US 2015/0243136 A1
(43) Pub. Date: Aug. 27, 2015

(54) SEAMLESS GAMING SYSTEM

(71) Applicants: Milo Borissov, Dubai Sports City (AE); Rossi McKee, Indianapolis, IN (US)

(72) Inventors: Milo Borissov, Dubai Sports City (AE); Rossi McKee, Indianapolis, IN (US)

(21) Appl. No.: 14/610,773

(22) Filed: Jan. 30, 2015

Related U.S. Application Data
(60) Provisional application No. 61/935,028, filed on Feb. 3, 2014.

(51) Int. Cl. G07F 17/32

(52) U.S. Cl. CPC G07F 17/3258; G07F 17/3225; G07F 17/329

(57) ABSTRACT

A seamless gaming system unifies and integrates land based gaming systems and associated gaming devices such as slot and video gaming machines, portable gaming devices and gaming tables; video lottery or server-based systems and associated terminals; online gaming systems; and associated systems and devices, such as jackpot controllers, money management systems and remote game servers.

### RELATED APPLICATION DATA

This application claims priority to U.S. Provisional Patent Application Ser. No. 61/935,028, filed Feb. 3, 2014.

### FIELD OF THE INVENTION

The present invention relates to gaming systems which are configured to present wagering games.

### BACKGROUND OF THE INVENTION

Originally casinos presented wagering games at physical tables or at individual mechanical slot machines. With the advent of modern electronic gaming machines and tables, gaming machines, tables and other gaming equipment could be linked to one another and/or with other devices. However, different systems were generally developed for different gaming related purposes. For example, a player tracking system might be developed and linked to multiple gaming machines to track player game play at the machines. A separate accounting system might be linked to the gaming machines to track wagers and other monetary transactions at the gaming machines. Thus, a single casino might end up operating multiple, different systems relative to its gaming machines.

With the advent of online and server-based gaming, additional complexities have arisen. Online and server-based gaming systems have been developed entirely separate from a casino's gaming system which links gaming machines on the casino floor. This is problematic for casinos or other operators who are then operating entirely different systems relating to traditional casino-style gaming machines, newer server-based gaming machines, and now online gaming systems.

### SUMMARY OF THE INVENTION

Embodiments of the invention comprise a seamless gaming system which unifies and integrates land based gaming systems and associated gaming devices such as slot and video gaming machines, portable gaming devices and gaming tables; video lottery or server-based systems and terminals; online gaming systems; as well as associated systems and devices, such as jackpot controllers, money management systems and remote game servers.

Further objects, features, and advantages of the present invention over the prior art will become apparent from the detailed description of the drawings which follows, when considered with the attached figures.

### DESCRIPTION OF THE DRAWINGS

FIG. 1 schematically illustrates a seamless gaming system in accordance with the present invention.

FIG. 2 illustrates an embodiment of a gaming machine to which the jackpot controller of the invention is applicable.

### DETAILED DESCRIPTION OF THE INVENTION

In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

Embodiments of the invention comprise a seamless gaming system. In accordance with the present invention all types of gaming systems and devices are linked, including, but not limited to: (1) one or more online gaming systems which are configured to present online games, such as to player computing or presentation devices; (2) one or more video lottery or server based gaming systems, such as which are configured to present games via video lottery or casino gaming terminals; (3) one or more casino gaming systems, such as including casino management servers (“CMS”) and associated gaming devices such as video and slot machines, gaming tables and other devices; (4) one or more jackpot systems, including jackpot controllers; (5) one or more money management systems; and (6) one or more remote game servers or systems.

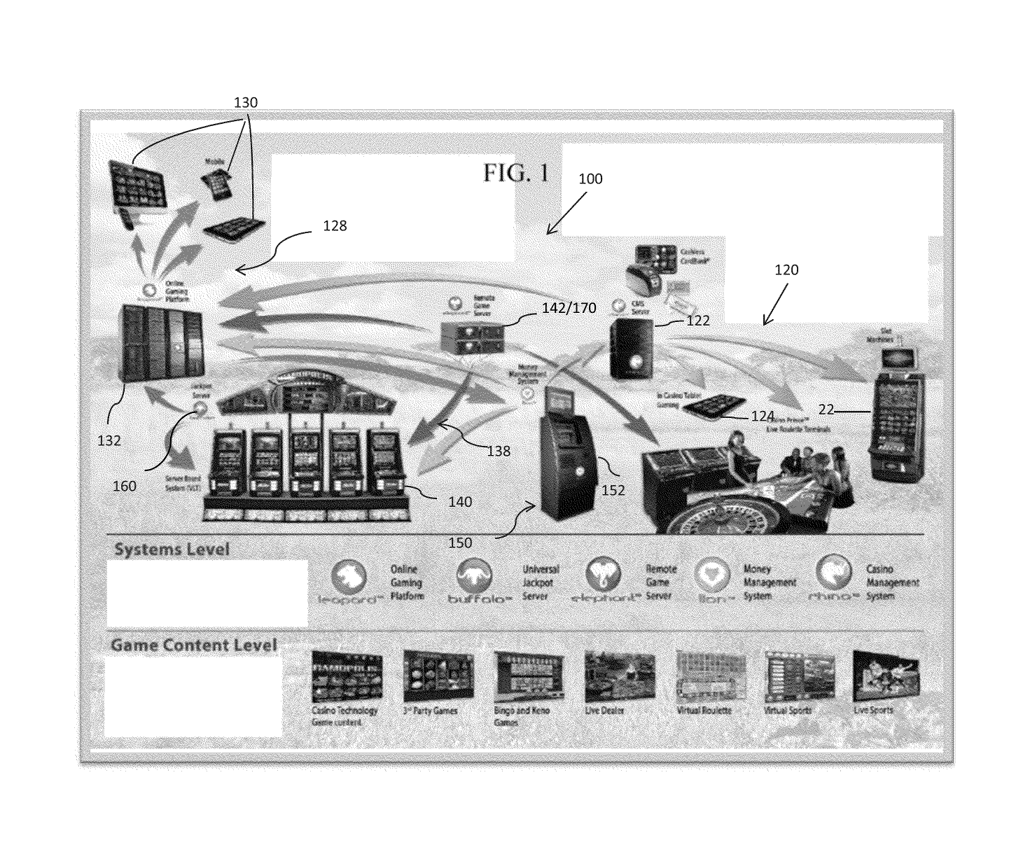

FIG. 1 schematically illustrates features of an integrated or seamless gaming system 100. The seamless gaming system 100 may include one or more traditional casino gaming systems 120. In those gaming systems 100, one or more gaming devices may be associated with a gaming or casino management system (“CMS”). Such a system may include at least one host or casino management server 122. The casino management host 122 may comprise one or more computing devices, such as servers, which are in communication with the gaming devices.

The gaming devices may comprise gaming machines 22, mobile gaming devices 124 such as hand-held or tablet devices, or other devices such as electronic gaming tables and the like, as are well known.

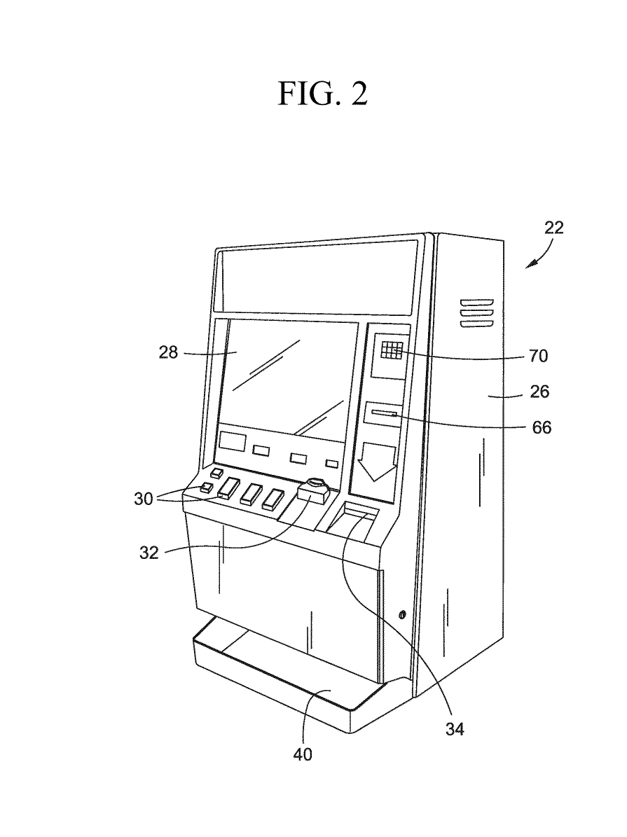

One example of a gaming machine 22 of a casino gaming system 120 is illustrated in FIG. 2. As illustrated, the gaming machine 22 generally comprises a housing or cabinet 26 for supporting and/or enclosing various components required for operation of the gaming machine. In the embodiment illustrated, the housing 26 includes a door located at a front thereof, the door capable of being moved between an open position which allows access to the interior, and a closed position in which access to the interior is generally prevented. The configuration of the gaming machine 22 may vary. In the embodiment illustrated, the gaming machine 22 has an “upright” configuration. However, the gaming machine 22 could have other configurations, shapes or dimensions (such as being of a “slant”-type, “bar-top” or other configuration as is well known to those of skill in the art).

The gaming machine 22 preferably includes at least one display device 28 configured to display game information. The display device 28 may comprise an electronic video display such as a cathode ray tube (CRT), high resolution flat panel liquid crystal display (LCD), projection LCD, plasma display, field emission display, digital micro-mirror display (DMD), digital light processing display (DLP), LCD touchscreen, a light emitting display (LED) or other suitable displays now known or later developed, in a variety of resolutions, sizes and formats (e.g. 4:3, widescreen or the like). The display 28 may be capable of projecting or displaying a wide variety of information, including images, symbols and other indicia or information associated with game play, game promotion or other events. The gaming machine 22 might include more than one display device 28, such as two or more displays 28 which are associated with the housing 26. The gaming machine 22 might also include a top box or other portion. Such a top box might include one or more display devices 28, such as in addition to one or more main displays which are associated with the housing 26. Also, the gaming machine 22 might include side displays (such as mounted to the exterior of the housing 26) and might include multiple displays of differing sizes.

As described in more detail below, the gaming machine 22 is preferably configured to present one or more games upon a player making a monetary payment or wager. In this regard, as described in more detail below, the gaming machine 22 includes means for accepting monetary value.

In one embodiment, as detailed above, certain game outcomes may be designated as winning outcomes. Prizes or awards may be provided for winning outcomes, such as monetary payments (or representations thereof, such as prize of credits), or promotional awards as detailed herein. As detailed below, the gaming machine 22 includes means for returning unused monetary funds and/or dispensing winnings to a player.

The gaming machine 22 preferably includes one or more player input devices 30 (such as input buttons, plunger mechanisms, a touch-screen display, joystick, touch-pad or the like). These one or more devices 30 may be utilized by the player to facilitate game play, such as by providing input or instruction to the gaming machine 22. For example, such input devices 30 may be utilized by a player to place a wager, cause the gaming machine 22 to initiate a game, to indicate cards to be held or discarded, to “cash out” of the gaming machine, or to provide various other inputs.

In one preferred embodiment, the gaming machine 22 includes at least one microprocessor or controller for controlling the gaming machine, including receiving player input and sending output signals for controlling the various components of the machine 22 (such as generating game information for display by the display 28). The controller may be arranged to receive information regarding funds provided by a player to the gaming machine, receive input such as a purchase/bet signal when a purchase/bet button is depressed, and receive other inputs from a player. The controller may be arranged to generate information regarding a game, such as generating game information for display by the at least one display 28 (such as information representing images of displayed cards, slot symbols or the like), for determining winning or losing game outcomes and for displaying information regarding awards for winning game outcomes, among other things.

The controller may be configured to execute machine readable code or “software” or otherwise process information, such as obtained from a remote server. Software or other instructions may be stored on a memory or data storage device. The memory may also store other information, such as pay table information. The gaming machine 22 may also include one or more random number generators for generating random numbers, such as for use in selecting cards and for presenting the game in a random fashion.

Preferably, the controller is configured to execute machine readable code or instructions which are configured to implement the method of game play of the invention. For example, the controller of the gaming machine 22 may be configured to detect a wager, such as a signal from a player's depressing of the “bet one” button. Upon such an event and/or the player otherwise signaling the gaming machine to present the game, the controller may be configured to cause game data to be displayed on the at least one display 28. The controller may accept input from a player of game inputs via the one or more player input devices of the gaming machine 22.

The gaming machine 22 may be configured to generate and present games in a stand-alone manner or it may be in communication with one or more external devices at one or more times. For example, the gaming machine 22 may be configured as a server based device and obtain game code or game outcome information from a remote game server (in which event the gaming machine controller may receive game information from the server, such as game outcome information, and use that server-generated information to present the game at the gaming machine).

As indicated, the gaming machine 22 is configured to present one or more wagering games. Thus, the gaming machines 22 is preferably configured to accept value, such as in the form of coins, tokens, paper currency or other elements or devices representing value such as monetary funds. For example, as illustrated in FIG. 2, the gaming machine 22 might include a coin acceptor 32 for accepting coins. Of course, associated coin reading/verifying devices and coin storage devices may be associated with the gaming machine 22 if it is configured to accept coins. Likewise, the gaming machine 22 might include a media reader 34. Such a reader may be configured to accept and read/verify paper currency and/or other media such as tickets. Of course, in such event the gaming machine 22 may further be configured with one or more paper currency or ticket storage devices, such as cash boxes, and other paper currency or media handling devices (including transport devices).

The gaming machine 22 might also be configured to read FOBs, magnetic stripe cards or other media having data associated therewith and via which value or funds may be associated with the gaming machine 22.

In one embodiment, the gaming machine 22 is configured to award winnings for one or more winning wagering game outcomes. Such winnings may be represented as credits, points or the like. In one embodiment, the player may “cash out” and thus remove previously associated funds and any awarded winnings or such may otherwise be paid to the player. For example, upon an award or at cash-out, associated funds may be paid to the player by the gaming machine 22 dispensing coins to a coin tray. In another embodiment, funds may be issued by dispensing paper currency. In yet another embodiment, a player may be issued a media, such as a printed ticket, which ticket represents the value which was paid or cashed out of the machine. The aspects of gaming machine “ticketing” systems are well known. One such system is described in U.S. Pat. No. 6,048,269 to Burns, which is incorporated herein in its entirety by reference.

The gaming machine 22 may also include a player tracking device, such as a card reader 66 and associated keypad 70. Such player tracking devices are well known and may permit the game operator to track play of players of the gaming machine. The tracked play may be utilized to offer player bonuses or awards.

It will be appreciated that the gaming machine illustrated in FIG. 2 is only exemplary of one embodiment of a gaming machine. For example, it is possible to for the gaming machine to have various other configurations, including different shapes and styles and having different components than as just described. Such gaming machines may be referred to a spinning reel or “slot” machines (such as when configured to include spinning reel type displays or to display spinning reel type video information) or video gaming machines, and may be configured to implement a variety of games now known or later developed, including, but not limited to slot games, poker games, blackjack games, lotteries, bingo games, keno games, roulette games, baccarat games and others.

The seamless gaming system 100 might include one or more online gaming systems 128. Such systems 128 might be configured to present games via communication links or networks to one or more computing or presentation devices 130, such as a home or office computer or a player's mobile electronic device such as a PDA, phone or the like. In one embodiment, one or more games (preferably wager based games) may be presented at those devices 130 via one or more online game servers 132. For example, a player might log into a game server 132 and the controller thereof might cause game information to be delivered to the player's computing device 130 via a communication link. The communication link might comprise or include the Internet and/or other networks, such as a wired or wireless LAN, or combinations of public and/or private networks including wired and/or wireless links. In such a configuration it will be noted that the term “controller” may comprise more than one device. For example, in a server-based environment, a controller at a server may generate game information and transmit that information to a local controller at a player's computing device. The local controller at the gaming machine or the player's computer or other electronic device may then cause game information to be displayed on one or more associated displays.

As illustrated in FIG. 1, the seamless gaming system 100 may also include one or more video lottery or server-based gaming systems 138. Such a system 138 might include one or more video lottery terminals (“VLTs”) 140 or similar devices, such as server-based casino gaming terminals. These video lottery or server-based casino terminals 140 may be display devices or computing devices which are configured to present one or more games, such as wagering games including video lottery games, or to display the outcomes of such games.

The terminals 140 may be associated with one or more servers 142, such as video lottery or casino game servers. The servers 142 may be connected to the terminals 140 and be configured to enable or track the presentation of video lottery games at the terminals 140.

The seamless gaming system 100 may also include at least one money management system 150. Such a system 150 may include one or more accounting servers or hosts 152 and various devices such as ticket-dispensing kiosks, ticket-cashing kiosks, cash-dispensing kiosks (such as from a credit card or debit card), ATMs, and/or other devices.

The seamless gaming system 100 may also include one or more jackpot systems 160 which are configured to present or enabled one or more jackpots. Such jackpots may be of any variety, such as based upon particular game events or outcomes or “mystery” jackpots, as are well known. The jackpots may be fixed or progressive value. The jackpot system 160 may comprise or be enabled by one or more jackpot controllers.

The seamless gaming system 100 may also include one or more remote game systems or servers 170. Such game servers 170 may be configured to generate or provide games or game content.

In accordance with the present invention, the various aspects of the seamless gaming system 120 are configured to communicate or interface with one another. For example, the one or more jackpot controllers of the jackpot system 160 may be configured to present one or more jackpots at any combination of online systems (and associated games), the video lottery or server-based systems, including the video lottery or casino game terminals 140, and/or the casino gaming system 132, including the gaming machines 22 or other gaming devices thereof. In this manner, an operator of the seamless gaming system 100 can centrally manage and operate jackpots across all gaming systems and devices.

Likewise, the money management system 150 is preferably linked to all of the gaming systems and devices. In this manner, an operator can centrally manage and track all money-related activities and transactions across all gaming systems and devices. This also permits the operator to centralize accounting for all such systems and devices.

As illustrated, the one or more remote game servers 170 may be linked to the various gaming systems, such as to provide games or game content to, or control game play at, gaming devices or terminals, including those of the casino gaming systems(s) 120, the server-based gaming system(s) 138 and the online gaming system(s) 128.

The various systems and devices may be configured to communicate with one another in various fashions. For example, each device may include one or more communication ports or interfaces. The devices may be linked by various communication links. These links may be wired or wireless, including local area networks (“LANs”), wide area networks (“WANs”), public or provide networks such as the Internet and the like. The devices may also be configured to communicate by various methods or protocols. For example, the devices might be configured to communicate using one or more standard communication protocols, such as the known System to System (“S2S”), Game to System (“G2S”) or Slot Accounting System (“SAS”) communication protocols. The devices might also be configured to implement or communicate via one or more application program interfaces (“APIs”). The devices could also communicate by one or more other protocols, such as TCP/IP.

Of course, the seamless gaming system 100 might include other systems or devices other than those just described.

Aspects of the invention may be implemented as hardware and/or software. For example, the jackpot controller may comprise computer software in the form of computer readable code executed on a general purpose computer, or in the form of bytecode class files executable within a Java™ runtime environment running on such a computer, or in the form of bytecodes running on a processor (or devices enabled to process bytecodes) existing in a distributed environment (e.g., one or more processors on a network).

Such a computer may include a video memory (not shown), a main memory (not shown) and a mass storage (not shown), all coupled to system bus (not shown) along with user inputs devices such as a keyboard and/or mouse (not shown), and one or more processors. The mass storage may include both fixed and removable media, such as magnetic, optical or magnetic optical storage systems or any other available mass storage technology. The system bus may contain, for example, thirty-two address lines for addressing video memory or main memory. The system bus also includes, for example, a 64-bit data bus for transferring data between and among the components, such as processor, main memory, video memory and mass storage. Alternatively, multiplex data/address lines may be used instead of separate data and address lines.

The computing device may also include a communication interface coupled to the system bus. Communication interface provides a two-way data communication with external systems and devices.

Application code may be embodied in any form of computer program product. A computer program product comprises a medium configured to store or transport computer readable code, or in which computer readable code may be embedded. Some examples of computer program products are CD-ROM disks, ROM cards, floppy disks, magnetic tapes, computer hard drives, servers on a network, and carrier waves. The computer systems described above are for purposes of example only. An embodiment of the invention may be implemented in any type of computer system or programming or processing environment.

The seamless gaming system of the invention has numerous advantages and features. For example, the invention permits the unification of land based gaming machines, VLT or server-based systems and terminals, and online gaming systems and games. In this manner, a single operator may link all of their gaming systems or devices. In accordance with the invention, systems are linked or unified at a systems level as well as at a game content level. This permits different games to be presented across the different systems or devices of the seamless gaming system, as well as promotions, money management, player tracking, jackpots and other gaming features to be centrally controlled and linked across all of the systems and devices.

It will be understood that the above described arrangements of apparatus and the method there from are merely illustrative of applications of the principles of this invention and many other embodiments and modifications may be made without departing from the spirit and scope of the invention as defined in the claims.

What is claimed is:

1. A seamless gaming system comprising:
at least one casino gaming system comprising at least one casino management server linked to a plurality of gaming machines configured to present wagering games;
at least one online gaming system comprising at least one online game server configured to present games to one or more wagering games to one or more remote presentation devices via one or more communication links;
at least one video lottery or server-based gaming system comprising at least one game server configured to present wagering games via one or more game terminals;
a money management system communicatively coupled to said at least one casino gaming system, said at least one online gaming system and said at least one video lottery or server based gaming system to centrally track and manage monetary transactions; and
a jackpot controller configured to present one or more common jackpots at said gaming machines, said presentation devices and/or said game terminals.

2. The seamless gaming system in accordance with claim 1 further comprising at least one remote game server communicatively linked to said at least one casino gaming system, said at least one online gaming system and said at least one video lottery or server-based gaming system.

3. The seamless gaming system in accordance with claim 1 wherein said jackpot controller is communicatively coupled to said at least one casino management server, said at least one online game server and said at least one game server.
